(19) United States
(12) Patent Application Publication
(10) Pub. No.: US 2007/0253196 A1
(43) Pub. Date: Nov. 1, 2007

(54) LED aquarium light

(75) Inventor: Patrick F. Ormiston, Vancouver, WA (US)

Correspondence Address: FSP LLC, P.O. BOX 890, VANCOUVER, WA, 98666, US

(73) Assignee: PFO Lighting, Vancouver, WA (US)

(21) Appl. No.: 11/642,366

(22) Filed: Dec. 20, 2006

Related U.S. Application Data
(60) Provisional application No. 60/795,844, filed on Apr. 27, 2006.

(51) Int. Cl. F21V 9/00

(52) U.S. Cl. 362/231

(57) ABSTRACT

An aquarium lighting system includes an LED array that includes multiple white light LEDs and multiple blue light LEDs. A control system separately controls a) the intensity of white light output by the white LEDs, and b) the intensity of blue light output by the blue LEDs.

### PRIORITY CLAIM

This application claims priority to the U.S. provisional patent application entitled LED AQUARIUM LIGHT, filed Apr. 27, 2006, having application No. 60/795,844, incorporated by reference herein in its entirety.

### TECHNICAL FIELD

The present disclosure relates to lighting systems.

### BACKGROUND

Special lighting is frequently provided for aquarium and horticulture applications. When in use, this lighting may be situated above the aquarium or horticulture system. The lighting may be incorporated within a housing or hood. Heretofore the words “housing” or “hood” will both be referred to as “housing”. The lighting and housing will together be referred to as the lighting system.

Sometimes, the lighting system will be designed to enhance the functionality and/or appearance of the items illuminated. For example, aquarium lighting may be designed with brightness and color content to enhance the appearance of the water and contents. The brightness and light source selected may be such that fish and plants receive enough light of a spectrum to encourage life and growth.

Lighting systems should be designed in a flexible fashion to deliver light quality suitable for the application. Salt water aquarium lighting systems in particular should maintain proper spectral output and intensity for maintaining the health of coral and fish. Salt water aquarium lighting systems should not produce excessive ultraviolet radiation and/or heat that can harm aquatic life.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of an embodiment of an LED array.

FIG. 2 is an illustration of an embodiment of a cross section of an LED array with heat sink and housing.

FIG. 3 is a perspective illustration of an embodiment of a 3×3 LED array with heat sink and housing.

FIG. 4 is a cross-sectional illustration of an embodiment of a 3×3 LED array with heat sink and housing.

FIG. 5 shows a relative spectral power distribution for a white LED.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

A lighting system may generally comprise LEDs, a means of turning on/off/or dimming such LEDs, a means of directing generated heat away from such LEDs, and an associated housing. The LEDs may be arranged in a two-dimensional array. In various embodiments the LED array may comprise a square, a rectangle, or another shape such as a circle, oval, octagonal, or triangular shape.

The light from LEDs may be directed by means of some transmitting element such as a lens or lenses. For example, each LED in an LED array may have an associated lens. Light may be directed so that at least substantially all of the bottom of an aquarium or other container is illuminated.

The LEDs comprising the array may be of multiple types, each type generating light of a particular spectrum. Separate on/off/dimming controls may be provided for each type of LED or for subsets of one or more LEDs of the array. Separate controls for each type of LED provide the lighting system user with flexibility in obtaining both an overall light intensity and also a spectrum mix.

In some implementations, controls may be provided to enable each type of LED to, by the user, be turned on, dimmed or brightened, or turned off. For example, the lighting system may comprise a mixed array of white phosphor LEDs generating a full white light spectrum, and blue LEDs emitting in the range of 420 to 480 nanometers. The user may be able to generate a pure blue light illumination for the bottom of an aquarium by turning off the white LEDs while keeping the blue LEDs on at some intensity. Or, he/she may be able to provide a pleasing mix of 80% blue 20% white by having both kinds of LEDs on, with the white dimmed to one quarter of the intensity selected for the blue. The intensity selection function for each LED type may contain markings or some other means such as a readout to enable the user to determine the relative brightness/spectrum mix he/she is selecting.

In some implementations, controls are provided for specific features which are known to be attractive to users of special lighting systems for various applications such as aquariums and horticulture. For example, for an aquarium lighting system implementation consisting of an array providing white light generating and blue light generating LEDs, it may be possible to with one control move from a mix of 100% white—0% blue continuously through 90% white, 80%, 60%, etc. to 0% white—100% blue. Presets may be provided at known desirable mixes, such as 90% blue/10% white, 80% blue/20% white, and 60% blue/40% white.

Moonlight simulation may be provided in some embodiments. Moonlight simulation may be provided by a subset of a particular type of LEDs, such as 4 blue LEDs, one located in each quadrant or corner of the array or subarray thereof, to provide by a combination of dimming and/or on/off values for a full moon, three quarter moon, half moon, and so on (i.e. lunar cycle illumination).

For horticultural applications, the LED array may consist of three types of LEDs, generating red, blue, and green light respectively. Each type of LED may have separate controls providing on/off/dimming functionality. Each control may also have markings or readings enabling the user to identify the lighting level of intensity he is selecting, and/or providing desirable presets, enabling the user to select different spectrums and light intensities for differing horticultural growth requirements.

Alternatively or additionally, the controls may directly enable settings which are known to be needed for various horticultural situations.

Still another feature which may be provided for both aquarium and horticultural uses is a timer associated with some or all of the controls so that the mix and intensity of LEDs could be controlled based on the time of day, and/or day of the week, month, or year.

For any array shape, LEDs of different types may be intermixed within the array. For example, in an array consisting of 5 rows of LEDs, with each row having 5 LEDs in it, the first row may consist of a blue LED, then a white LED, and so on. The second row may consist of a white LED, then a blue, etc. The third row may consist of a blue LED, then a white, and so on.

Merely by way of example, for a horticultural application with a 6×6 LED array, the first row may comprise a red LED, then a green, then a blue, then a red, etc. The second row may comprise a blue LED, then a red, then a green, then a blue, etc. The third row may comprise a green LED, then a blue, then a red, then a green, etc.

Other mixing of LED types within the array may also occur, depending on the intended usage.

In many embodiments, the LED array may be either rectangular or square in shape. The shape of the LED array may be selected based at least partially on the shape of the area it is to illuminate. For example, a rectangular aquarium may have a square or rectangular LED array within a (probably) rectangular housing which sits on top of the tank.

Because LEDs generate heat, a heat sink feature may be provided to carry heat away from the LED array. Because the light emitting LEDs will typically be oriented downward when the housing is sitting on top of a container, the heat sink may be thought of as sitting on top of the LED array. The LED array, whatever the shape, may be considered to comprise a series of rows of LEDs (although the rows need not necessary be straight lines). Associated with each row is a heat sink strip, consisting of a material conductive of heat, such as a metal. Each heat sink strip may be attached to additional structure of the heat sink. This upper part may be detachably attachable to the lighting system housing. Parts of the heat sink may touch the housing. There may be enough contact between the heat sink and the housing so that heat originally generated by the LEDs may be dissipated through the housing.

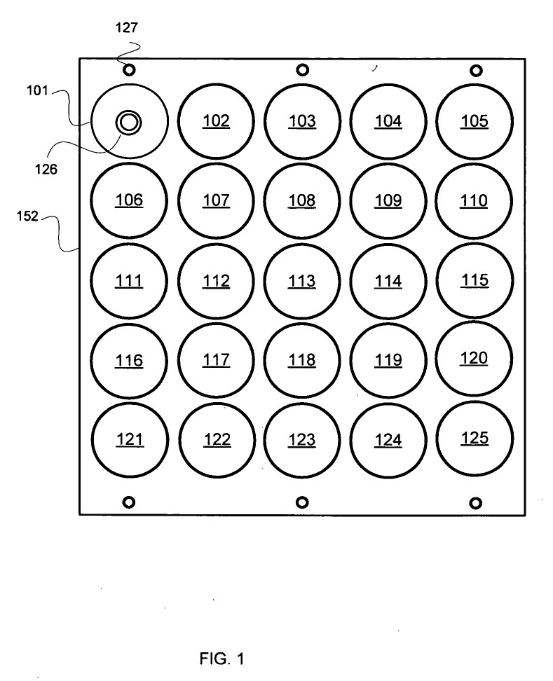

FIG. 1 is an illustration of embodiment of an LED array. The LED array 152 comprises 25 LED assemblies. The LED assemblies 101-125 comprise blue LED assemblies 101, 103, 105, 107, 109, 111, 113, 115, 117, 119, 121, 123, and 125. The LED assemblies 101-125 also comprise white LED assemblies 102, 104, 106, 108, 110, 112, 114, 116, 118, 120, 122, and 124. Each LED assembly 101-125 comprises an LED and a lens which directs the light of the LED.

In one embodiment, separate controls are provided by which a user may directly turn on/off or dim/brighten either the blue LEDs (odd numbered LED assemblies 101-125) or the white LEDs (even numbered LED assemblies 102-124). Each control may comprise markings or readouts such that the user can tell at what level of intensity he/she is selecting.

In some embodiments, the user may alternatively or additionally be able to directly control the mix of blue and white light. Thus one control may enable the user to continuously select a range of settings from 100% blue—no white to % 100 white—no blue light. Alternatively or additionally, the user may be able to select directly certain popular settings such as 80% blue/20% white or 60% blue/40% white. In these embodiments, the user may also be able to control the intensity of the mix.

In some embodiments, other features such as a moonlight simulation may be selectable. For example, a subset of blue LEDs 107, 109, 117, and 119 (the “blue moonlight” LEDs) may be controllable separately from the other LEDs. Thus all other LEDs may be off, while the blue moonlight LEDs may be on with intensity levels providing for full moonlight, three quarter light, half light, and so on according to the lunar cycle.

In some embodiments, separate control of banks of LED lights may be provided. For example, it may be possible to turn on LEDs and control them in various ways on one side of the array (thus illuminating one side of the aquarium or horticultural container) while separately controlling or leaving off the LEDs on the other side. In aquarium applications, this may provide fish a lighted area to enjoy and unlighted water to possibly hide in.

The LEDs in LED assemblies 101-125 may also be associated with a timing feature, either in total or associated with their separate controls. Thus, for example, a low illumination level may be selected for early morning, higher illumination during the afternoon, moderate illumination in the early evening, and no illumination during full night. Timing control may vary depending on how the LEDs of the lighting unit are controlled and the features provided by the timing controls.

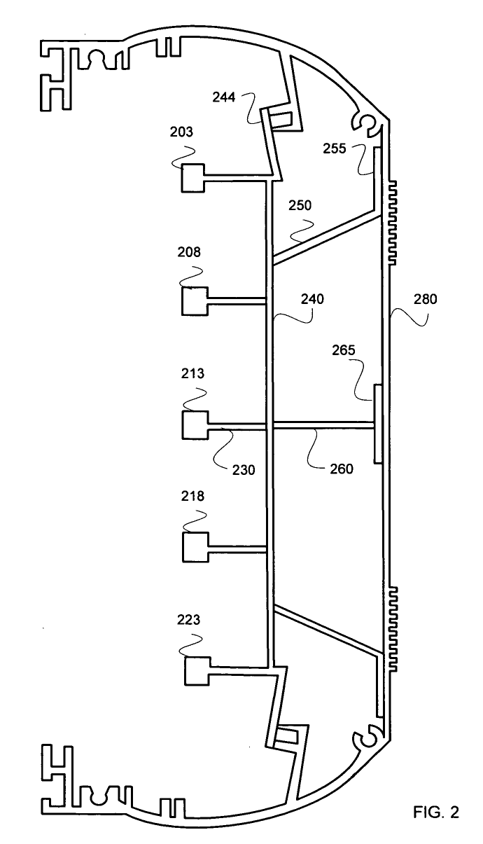

FIG. 2 is an illustration of an embodiment of a cross section of an LED array with heat sink and housing. A two-level heat sink system is employed, with a primary heat sink in contact with the board to which the LEDs are mounted, and the secondary heat sink formed by the lighting system housing 280. The cross section is for an LED array such as the one illustrated in FIG. 1, with the cutout illustrated through LED assemblies 103, 108, 113, 118, and 123. Each LED assembly 103, 108, 113, 118, and 123 comprises an LED and a lens. This cross section was taken to cut across the LED rows as they were described in FIG. 1, so each LED assembly 103, 108, 113, 118, or 123 shown is a part of a different LED row.

Associated with each LED row is a heat sink strip, shown as cross sections 203, 208, 213, 218, and 223. Each heat strip provides heat conduction away from a row of LEDs. For example, the heat strip labeled 213 provides heat transfer away from LEDs 111-115 as shown in FIG. 1 (only LED 113 is shown in FIG. 2). Each heat strip is attached to (or includes) other conductive material in the heat sink to which to transfer its heat. For example, heat strip 213 is attached to (or includes) conductive material 230 which attaches to other parts of the heat sink such as 240 which attaches to parts 250, 260, 244 and so on. Some parts of the heat sink such as 244 may be used to attach the heat sink to the housing 280. Some parts of the heat sink such as 255 and 265 may be in contact with portions of the housing, such that heat from the heat sink may be dissipated through the housing.

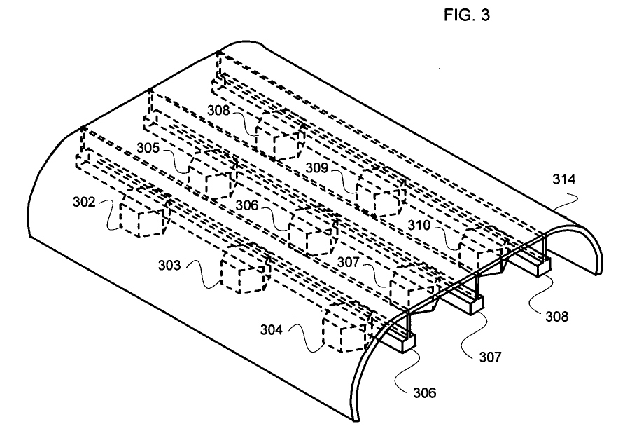

FIG. 3 is a perspective illustration of an embodiment of a 3×3 LED array with heat sink and housing. The LED array comprises LED assemblies 302-310. The LED assemblies 302-310 comprise a mixture of blue, white, and possibly cyan LEDs. Each LED assembly 302-310 comprises an LED and a lens and a lens housing that act to direct the light of the associated LED.

In some embodiments, the lens and housing of the LED assemblies 302-310 may comprise a ‘widebeam’ dispersion, so that the dispersion angle is between 40-45 degrees. For example, blue LED assemblies may have a dispersion angle of approximately 42 degrees, and white assemblies a dispersion angle of approximately 45 degrees.

A heat sink system is employed, with a primary heat sink 306-308 in contact with the LED assemblies 302-310. A secondary heat sink is formed by the lighting system housing 314.

Associated with each LED row is a primary heat sink strip 306-308. Each strip 306-308 provides heat conduction away from a row of LEDs. Each strip 306-308 may be coupled to the housing 314. Consequently, heat from the LED assemblies 302-304 may be conducted through the strips 306-308 and dissipated through the housing 314.

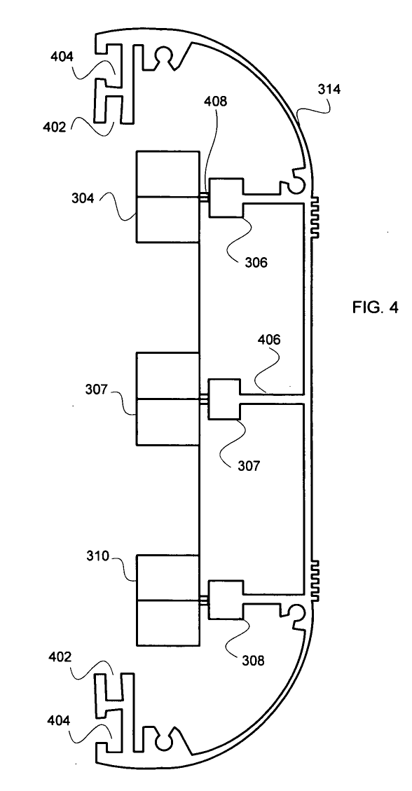

FIG. 4 is a cross-sectional illustration of an embodiment of a 3×3 LED array with heat sink and housing. LED assemblies 304, 307, and 310 are visible in the cross section.

A heat sink system is employed, with a primary heat sink 306-308 in contact with the LED assemblies, and the secondary heat sink formed by the lighting system housing 314. The LED assemblies 304, 307, 310 are coupled to the strips 306-308 via heat conductive elements 408, which may be metal or other materials known in the art. Each strip 306-308 includes conductive material such as 406 for strip 307 by way of which to transfer its heat to the housing 314.

The housing 314 includes a formation 404 to fit the LED fixture onto a container, for example, an aquarium. The housing 314 also comprises a formation 402 into which a transparent or translucent cover, composed for example of glass, fiberglass, or plastic, may be placed. The cover protects the LED assemblies from whatever may be enclosed in the container, for example, salt water.

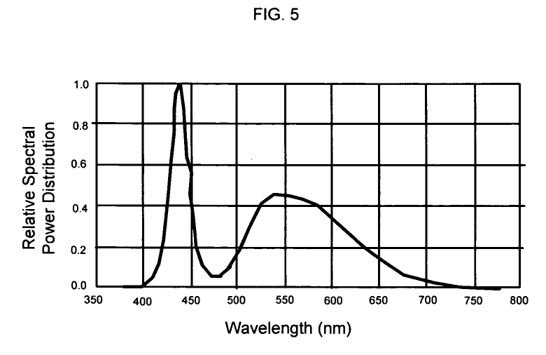

FIG. 5 shows a relative spectral power distribution for a white LED. The white LED has a peak power output around 445 nanometers, with the shape of the output being such that the averaged output in the blue wavelengths occurs around 450, which is approximately true blue. However, the power output does not continuously taper with higher wavelengths. Thus it may be considered to have a “fat tail” comprising significant power output in wavelengths which are not blue. Twenty percent to forty percent of peak power is found between 500 and 635 nanometers, which are green, yellow, orange, and orange red light. The power spectrum output for the LED is thus not necessarily that which is perceived by a viewer as most pleasing. Supplementing the power spectrum with other LED types such as cyan and blue may improve the aesthetics as well as the usefulness for maintaining the health of aquatic species.

An LED assembly which mixes LED types may be able to compensate for the imperfect spectral power distribution of individual LEDs, resulting in more enjoyable viewing and healthier aquatic species. For example, placing several cyan LEDs in an assembly of blue and white LEDs may even the power spectrum, particularly in the 450-550 nm range, so that the spectral components are more evenly distributed in power. To further control the resulting spectral output, the LED assembly may be designed so that the various LED types may provide light at greater or lesser intensity, depending on what is needed to optimize the spectral power distribution. In some situations, as differing light spectral distribution may be desired under different circumstances, controls to vary the output either to all LED types or by type may be provided, as was described in FIG. 1.

What is claimed is:

1. A aquarium lighting system comprising an LED array comprising:
multiple white light LEDs;
multiple blue light LEDs; and
a control system for separately controlling a) the intensity of white light output by the white LEDs, and b) the intensity of blue light output by the blue LEDs.

2. The aquarium lighting system of claim 1, wherein the control system further comprises:
presets for 90% blue and 10% white, 80% blue and 20% white, and 60% blue and 40% white.

3. The aquarium lighting system of claim 1, wherein the multiple blue light LEDs further comprise:
a subset of blue light LEDs within the multiple blue LEDs, the subset separately controllable from the multiple blue LEDs for moonlight simulation.

4. The aquarium lighting system of claim 1, wherein the control system further comprises:
a timer for automatically varying the relative output power of white and blue light from the array according to a time of day, and-or day of the week, month, and-or year.

5. The aquarium lighting system of claim 1, further comprising:
the blue light and white light LEDs alternately intermixed in the array.

6. The aquarium lighting system of claim 1, further comprising:
the LED array is one of rectangular, square, circular, or oval.

7. The aquarium lighting system of claim 1, further comprising:
multiple cyan light LEDs.

8. The aquarium lighting system of claim 1, further comprising:
a heat sink system mounted to the LED array.

9. The aquarium lighting system of claim 8, wherein the heat sink system mounted to the LED array further comprises:
a primary heat sink comprising rows of conductive material aligned with the backing of LEDs of the array, and a secondary heat sink comprising a housing of the LED array.
